(19) United States
(12) Patent Application Publication
(10) Pub. No.: US 2005/0027664 A1
(43) Pub. Date: Feb. 3, 2005

(54) Interactive machine learning system for automated annotation of information in text

(76) Inventors: David E. Johnson, Cortlandt Manor, NY (US); Sylvie Levesque, Croton-On-Hudson, NY (US); Tong Zhang, Tuckahoe, NY (US)

Correspondence Address: McGuireWoods LLP, Suite 1800, 1750 Tysons Boulevard, McLean, VA, 22102-3915, US

(21) Appl. No.: 10/630,854

(22) Filed: Jul. 31, 2003

(51) Int. Cl. G06F 15/18

(52) U.S. Cl. 706/12; 715/512

(57) ABSTRACT

An interactive machine learning based system that incrementally learns, on the basis of text data, how to annotate new text data. The system and method starts with partially annotated training data or alternatively unannotated training data and a set of examples of what is to be learned. Through iterative interactive training sessions with a user the system trains annotators, and these are in turn used to discover more annotations in the text data. Once all of the text data or a sufficient amount of the text data is annotated, at the user's discretion, the system learns a final annotator or annotators, which are exported and available to annotate new textual data. As the iterative training process occurs the user is selectively presented for review and appropriate action, system-determined representations of the annotation instances and provided a convenient and efficient interface so that context of use can be verified if necessary in order to evaluate the annotations and correct them, where required. At the user's discretion, annotations that receive a high confidence level can be automatically accepted and those with low confidence levels can be automatically rejected.

### BACKGROUND OF THE INVENTION

1. Field of the Invention

The invention generally relates to identifying, demarcating and labeling, i.e., annotating, information in unstructured or semi-structured textual data, and, more particularly, to a system and method that learns from examples how to annotate information from unstructured or semi-structured textual data.

2. Background Description

Businesses and institutions receive, generate, store, search, retrieve, and analyze large amounts of text data in the course of daily business or activities. This textual data can be of various types including Internet and intranet web documents, company internal documents, manuals, memoranda, electronic messages commonly known as e-mail, newsgroup or “chat room” interchanges, or even transcriptions of voice data.

If important aspects of the information content implicit in electronic representations of text can be annotated, then the text in those documents or messages can be automatically processed in various useful ways. For instance, after key aspects of the information content is automatically annotated, the resulting annotations could be automatically highlighted as an aid to a reader, or they could be used as input to a natural language processing, knowledge management or information retrieval system that automatically indexes, categorizes, summarizes, analyses or otherwise organizes or manipulates the information content of text.

In many instances, information contained in the text of electronic documents and messages are critical to the free flow of information among organizations (and individuals), and methods for effectively identifying and disseminating key information is integral to the successful operation of the organization. For instance, automatically annotating key information in text as a precursor to indexing can improve search, e.g., if a system annotates the sequence of tokens “International”, “Business”, “Machines”, “Corporation” as a single entity of type “Company” or uses this annotation to further extract and format the information in a simple template or record structure, e.g., [Type: Company, String: “International Business Machines Corporation”], then such information could be used by a subsequent search engine in matching queries to responses or to organize the results of a search.

Further, if the system were to further identify alternate ways of referring to a single entity, e.g. in the case above, the system might identify the following terms—“IBM”, “Big Blue”, “International Business Machines Corporation”, then this information could be used to index documents with a single meta-term. Given this capability, a search system could match a query term “IBM” to documents containing the semantically co-referent but non-identical and morphologically unrelated term “Big Blue”, resulting in providing more complete yet accurate responses to the search query.

In so-called Question Answering systems, questions such as “What company has its headquarters in Armonk, N.Y. ?” or “Where is the headquarters of Big Blue?” could be more effectively answered if the documents implicitly containing the answers were accurately indexed not just with tokens but also with semantically equivalent meta-terms. Annotation of entity names can also improve the results of machine translation systems.

Electronic messages and documents are very often routed, via a mail system (e.g., server), to a specific individual or individuals for appropriate actions. However, in order to perform a certain action associated with the electronic message (e.g., forwarding the message to another individual, responding to the message or performing countless other actions, and the like), the individual must first read the text, identify the key information and interpret it before performing the appropriate action. This is both time consuming and error prone. It would be advantageous to have the text automatically annotated with key information that can be used to determine who should receive the information and/or be used by the person responsible for taking the appropriate action.

To further complicate matters, in large institutions, such as banks, electronic messages are routed to the institution generally, and not to any specific individual. In these instances, several individuals may have a role in opening, reading and interpreting the incoming messages, either to properly route the messages, reply to them or otherwise take appropriate actions. Having multiple people read, identify and interpret the same text information is inefficient and error prone. Here too it would be advantageous to have an automated system annotate key information, which would then be made available to anyone who processes the message, insuring that everyone has immediate access to the same information.

In information mining and analysis, annotating key information or concepts implicit in a document or message is also important as an aid in quickly identifying and understanding the critical information in the text. Such annotations can also provide critical input to other automated reasoning processes. There is a problem, however, in achieving the goal of automated annotation of text, viz., it is not currently possible to compile a complete list of instances of all possible or entity or class types, including companies, organizations, people names, products, addresses, occupations, diseases and the like. Indeed the class of entity types itself is open-ended. To further complicate matters, the same process is needed for different natural languages, e.g., English, German, Japanese, Korean, Chinese, Hindi, etc. thus, for a search system to make use of named entity or class annotations for arbitrary types of entities or classes, it must include a system for dynamically learning to annotate documents with named entities or classes. Moreover, many such instances are ambiguous out of context, and hence accurately annotating text requires a system that can determine if a specific instance in a particular context denotes a particular entity in that context, e.g., “Lawyer” can be the name of a city, but it is not a city in the context of “Lawyer Jack Jones successfully defended . . . ”.

As the information in text documents is often extremely large and growing at an enormous pace, it is not feasible to develop lists of named entities such as companies, products, people, addresses, etc. Thus, developing a system for annotating arbitrary named entities is complicated, and given the current state of the art, requires special expertise. For example, some systems for annotating text rely on experts to manually develop computer programs or formal grammars that annotate entities in text. This approach is extremely time consuming, requires expertise in computational linguistics, linguistics or artificial intelligence or related disciplines, or some combination thereof, and the resulting systems are difficult to maintain or to transfer to new domains or languages. Other known systems are based on machine learning techniques, which on the basis of training data (documents with example annotation instances marked up), attempt to learn how to annotate new instances of the entities in question.

Although machine learning techniques provide fundamental advantages over manually created systems, machine learning techniques still require a large amount of accurately annotated training data to learn how to annotate new instances accurately. Unfortunately, it is typically not feasible to provide sufficient, accurately labeled data. This is sometimes referred to as the “training data bottleneck” and it is an obstacle to practical systems for so-called named entity annotation. Moreover, current machine learning systems do not provide an effective division of labor between a person, who understands the domain, and machine learning techniques, which although fast and untiring, are dependent on the accuracy and quantity of the example data in the training set. Although the level of expertise required to annotate training data is far below that required to build an annotation system by hand, the amount of effort required is still great so that such systems are either not sufficiently accurate or costly to develop for widespread commercial deployment.

Also, all data is not equally useful to a machine learning system, as some data items are redundant or otherwise not very informative. Having a person review such data would, therefore, be costly and an inefficient use of resources. Further, since machine learning accuracy improves with greater amounts of correctly annotated training data, no matter now much data a person or persons could annotate within the time and resource constraints for a particular machine learning tasks, it would always be desirable to have a system that can leverage these annotations to automatically annotate even more training data without requiring human intervention. Given that there are cost and time limitations to the amount of text data people can annotate, commercial success of automated annotation systems requires an effective technique for learning accurate automated annotators.

### SUMMARY OF THE INVENTION

In a first aspect of the invention, a method is provided for learning annotators for use in an interactive machine learning system. The method includes providing at least partially annotated text data or unannotated text data with seeds or seed models of instances of at least one named entity or class to be learned and iteratively learning annotators for the at least one named entity or class using a machine learning algorithm from the at least one named entity or class. Applying the learned annotators to text data results in the annotation of at least one named entity or class annotation instance. The representations of annotation instances identified by the learned annotators are selectively presented for review and correction, if determined.

In another aspect of the invention, the method includes providing examples of a type of a named entity and unannotated textual data and iteratively learning annotators based on at least one of the examples of a named entity and unannotated textual data. At the end of each iteration, any annotation, generated from the learned annotators, having a confidence level within a confidence level range is corrected based on feedback.

In yet another aspect of the invention, the method includes a user sequentially labeling documents in a document set and a machine learning algorithm concurrently training on a current set of labeled documents to learn at least one annotator for at least one named entity or class. The machine learning algorithm assigns a confidence level to each annotation instance of the learned annotators such that any annotation instance above a predetermined confidence level threshold will be presented to the user for review and possible correction in a current document being labeled.

In still another aspect, an apparatus is provided which includes a mechanism for providing at least partially annotated text data or unannotated text data with seeds or seed models of instances of at least one named entity or class to be learned and a mechanism for iteratively learning annotators for the at least one named entity or class using a machine learning algorithm from the at least one named entity or class. The apparatus further includes a mechanism for selectively presenting for review and correction, if determined, representations of annotation instances identified by the learned annotators.

In yet still another aspect, an apparatus includes a mechanism for providing examples of a type of a named entity and unannotated textual data and a mechanism for iteratively learning annotators based on at least one of the examples of a named entity and unannotated textual data. At the end of each iteration, any annotation, generated from the learned annotators, having a confidence level within a confidence level range is reviewed and, if required, corrected based on feedback.

Another aspect of the invention provides a computer program product comprising a computer usable medium having a computer readable program code embodied in the medium, the computer program product includes various software components.

### BRIEF DESCRIPTION OF THE DRAWINGS

FIG. 1 is an illustrative block diagram of an embodiment of the invention;

FIGS. 2A and 2B are flow diagrams illustrating the steps of using the invention; and

FIG. 3 is a flow diagram illustrating the steps of generally assigning and using confidence levels in determining annotation instances according to the invention;

FIG. 4 is a flow diagram illustrating steps of incrementally learning and applying annotators to a document concurrently with the user's annotation actions; and

FIG. 5 shows an overall relationship of the seeding process and alternative learning strategies.

### DETAILED DESCRIPTION OF EMBODIMENTS OF THE INVENTION

The invention is directed to a semi-automatic interactive learning system and method for building and training annotators used in electronic messaging systems, text document analysis systems, information retrieval systems and similar systems. This system and method of the invention reduces the amount of manual labor and level of expertise required to train annotators. In general, the invention provides iteratively built annotators whereby at the end of each iteration, a user provides feedback, effectively correcting the annotations of the system. After one or more iterations, a more reliable automated annotator system is produced for exporting and general use by other applications so that documents may be automatically analyzed using the annotation system to perform further operations on the documents such as, for example, routing or searching of the documents.

The interactive learning system and method of the invention interactively develops on the basis of training data, an incrementally improved set of one or more automated annotators for annotating instances of types of entities (e.g., cities, company names, people names, product names, etc.) in unstructured or semi-structured electronic text. The interactions comprise, in an embodiment, a series of training “rounds”, where each round may include, for example, a seeding phase providing examples, a learning phase, a selective presentation phase, and an evaluation and correction phase. In this manner, the system and method of the invention produces a final set of one or more annotators to be used by a general annotator-applier on arbitrary text input, which determines specific instances of annotations and in addition, assigns confidence levels indicating the likelihood that annotation instances are correct. In another embodiment or mode of use, learning takes place in the background at the same time that a user annotates a current document and the system provides suggestions to the user in the current document. In embodiments, a user can switch learning modes from iterative to concurrent and vice versa.

By way of further illustration, the invention may include stages such as, for example,
(1) training data preparation involving starting from a set of seed examples or seed models provided by a user or derived from some other source, e.g., lists, dictionaries, glossaries, patterns or database entries,
(2) annotator learning involving iteratively building annotators where at the end of each iteration, the user provides feedback correcting the annotations of the system at that stage, or alternatively a concurrent “walk-through” mode of learning, in which as the user labels data, the learner learns in the background concurrently and makes suggestions to the user, and
(3) human review whereby after all the data is labeled or the user is satisfied with the results at the current stage or otherwise chooses to stop, the system learns a final set of one or more annotators from the data labeled by the last iteration.
   This system and method allows the user to provide feedback or supervision in various ways that speed up the learning and annotating process and reduce the amount of manual effort by, for example, providing for the manipulation of lists of annotated items rather than requiring users to examine tokens in documents and for selective presentation by the system to the user of lists of annotation instances whose confidence levels fall within an (adjustable) confidence range.

To start the iterative mode of learning process, a user provides directly or indirectly via at least one of several optional means, a sample of text with selective portions of the text annotated, which includes using an editor to bracket and label named entity instances in the text, providing a list or lists of named entities (dictionaries or glossaries), or providing a pattern or patterns in the system provided pattern language. The system and method then interprets these seeds, dictionaries or patterns in an appropriate manner with the result that all instances of the provided annotated examples, lists of items or examples implicit in the provided patterns are annotated in the user provided unannotated data, providing the initial training data. In the case of user-provided patterns, the system, via standard techniques well known in the art, interprets the patterns with respect to the unannotated text and marks the annotations that conform to the patterns. In all cases of seeding, the result is that some portions of the training data are annotated with instances of the named entity class or classes that are to be learned. Annotations can be represented in a variety of formats, languages and data structures, e.g., extensible markup language (XML), which is well known in the art.

It should be understood that named entities are not restricted to the category of proper names or proper nouns, but can correspond to any syntactic, semantic or notional type that can be identified as a type and named, e.g., occupations (doctor, attorney), diseases (measles, AIDS), sports (soccer, baseball), natural disasters (earthquake, tidal wave), medical professions (doctor, nurse, physician's assistant), verbal activities (arguing, debating, discussing). Thus, for purposes of the invention, a named entity could be any individual or class of identifiable type.

After this initial stage, the system and method of the invention learns to annotate new data based on the initial training data. After the learning stage, the system and method can then annotate the unannotated data, assigning a confidence level to each annotation instance. In one aspect of the invention, the seed data may not provide enough annotations to allow the learning system to accurately annotate all the training data. The unannotated portions of the training data may, in an embodiment, contain instances of the kinds of named entity class or classes to be learned and some of the current annotations will be in error. The system and method examines the annotations that have been assigned by the learned annotator(s) and their respective confidence levels, and based on this information selectively presents some of the learned annotations to the user for evaluation and correction, if needed. In general, the confidence levels assigned to annotation instances are related to the accuracy and effectiveness of the invention.

Among other functions, the system and method of the invention maintains a log of user corrections so that if a person removes an annotation instance or alters the class name of an annotation instance, and if later the invention attempts to re-annotate that instance incorrectly, the system will override the learning algorithm's assignment. In addition, the invention maintains a record of the seeds so that these annotations will not be overridden in the course of later learning.

The system and method, via the use of confidence levels and filtering of results, insures that (i) the selective presentation of annotation instances is effective so the user need not review all of the training data and (ii) the annotations assigned to the unannotated portions of the training data are correct. The first function minimizes human labor and the second function provides accurate annotators, as an output, typically used by other applications.

At the end of each training-data annotation iteration, the user may provide feedback in a specific manner that, in effect, corrects the annotations of the system at this iteration stage. In this manner, the effective learning of subsequent training iterations becomes incrementally more effective. After one or more iterations, or whenever the user is satisfied that each annotator has reached acceptable effectiveness, or the user simply chooses to stop the training, at that stage the system and method is capable of learning a final set of one or more annotators from the data labeled in the last iteration, i.e., of generating a final set of annotators for use in a runtime system.

### SYSTEM OF THE INVENTION

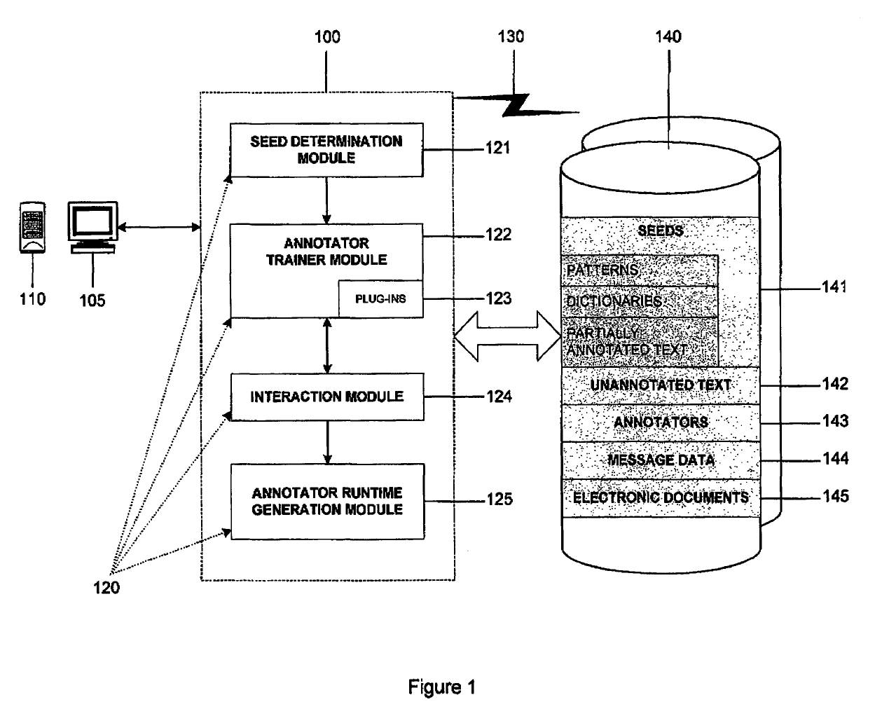

Referring now to the drawings, and more particularly to FIG. 1, the invention provides as an illustrative embodiment, a computer based platform 100, which may be a server, with an input device 105 (shown with disk 110) for a user to interact with the software modules, collectively shown as 120, of platform 100. The software modules may run under control of an operating system of which many are well known. The software modules 120 are used to train annotators, etc., as discussed in more detail below.

In an embodiment, the software modules 120 comprise a seed determination module 121, an annotator trainer module 122 with supporting plug-ins 123 for flexibly updating and modifying particular algorithms or techniques associated with the invention (e.g., feature vector generation, learning algorithm, parameter adjustments, an interaction module 124, and a final annotator runtime generator module 125. The platform 100 may have communication connectivity 130 such as a local area network (LAN) or wide-area network (WAN) for reception and delivery of electronic messaging which may involve an intranet or the Internet. The software modules 120 can access one or more databases 140 in order to read and store required information at various stages of the entire process. The database stores such items as seeds 141, unannotated text 142, annotators 143 including final annotators for exporting and use in runtime applications to annotate message data 144 or new electronic text documents 145. The database 140 can be of various topologies generally known to one of ordinary skill in the art including distributed databases. It should be understood that any of the components of platform 100 and also the database 140 could be integrated or distributed. The software modules 120, in an embodiment, may be integrated or distributed as client-server architecture, or resident on various electronic media.

In an embodiment, the development of an annotator typically involves three stages including seeding, annotator learning and after each learning stage, human evaluation and, if needed, correction of some of the new annotation instances determined at the end of an iteration. Evaluation might optionally include testing on a “hold out” set of pre-annotated data but one of the advantages of the invention is that testing on a “hold out” set is not necessary. This is because in the course of iteratively learning, annotating the corpus and receiving feedback from a person, including corrections, the system and method of the invention is, in effect, being tested, and through this interactive process converges on accurate annotators with minimal human effort, especially as compared to the effort that would be required to annotate the entire training corpus manually.

In the invention, the system is provided a corpus of text data and a set of seeds. Seeds can be either patterns describing instances of named entities, dictionaries or lists of named entities, or references to instances of named entities in the corpus of text data, which we refer to as “partially annotated text” or “annotation instances”.

It should be kept in mind that the training of annotators is completely automatic given the training data, requiring no decisions or actions on the part of the user. Specifically, the machine learning components of the invention learn how to annotate the text by learning how to assign classes to tokens and these token-level class assignments are then the input to the annotation assignment components that determines the labeled bracketing of the text indicating the span and label of individual annotations (i.e., annotation instances). At each learning stage, no human intervention is typically required to be involved in this process.

If at the start, one provides a corpus of partially pre-annotated textual data, the next step would, typically, be training. However, at the option of the user, additional seeds could also be provided before initiating training. If, on the other hand, one provides only a corpus of totally unannotated text data, then before training, one must perform the process of providing seeds, either via providing lists of examples, e.g. a list of company names, or annotating some instances in the provided text, or providing a pattern or patterns that can be interpreted by the system and applied to the unannotated corpus to identify some examples of what is to be learned and automatically annotate these examples. One method for providing patterns is to provide regular expressions, which can be used by a regular expression pattern matcher. Restating the above, at the end of the initial stage, the system has at its disposal a corpus of partially annotated text data. Sometimes the partially annotated text data provided initially to the learning phase are also referred to as “seeds”. Given seeds, the system and method learns an initial set of annotators (one for each kind of entity type to be learned) and then after receiving feedback from a person, in an embodiment, will undergo another round of learning.

As used in the invention, seeds refer to examples of named entity or classes that are used by the system to identify instances of named entities of classes in the text to create annotation instances(occurrences) of named entity or class instances in the text (which can be implemented by in-line annotation or even out-of-line annotation; how to do this is commonly understood in the state of the art). By way of example, seeds could be at least one annotation instance in the text itself, which would trivially determine itself as an example, or via search determine other examples in the text; a list or list of examples, a dictionary or glossary of examples, or database entries. As used in the invention, a seed model is any pattern, rule or program that, when interpreted, determines either seeds, which indirectly determine annotation instances in text or directly determines annotation instances in text. In this context, search is also considered a seed model.

It is noted that while the system and method internally learns for each annotator, a set of token classifiers, the number of which depends on the specific coding scheme, the user does not need to directly manipulate these token-level classifications and so does not have to deal with the internals of the learning process. That is, the results of learning are communicated to the user in terms of text, labeled annotations of named entities, and lists of named entities, which are the appropriate levels of abstraction and representation for a user, who can readily understand whether a presented named entity instance is correct or not, and can readily mark up text with annotations of named entities, but could not be expected to understand the token-level classification scheme.

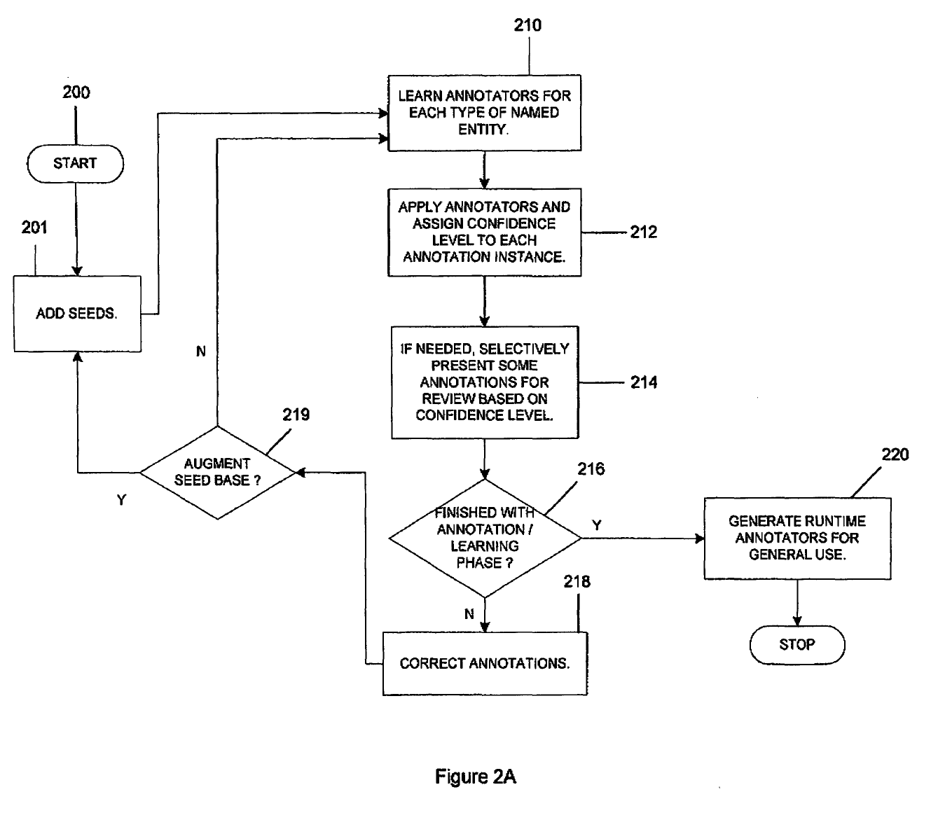

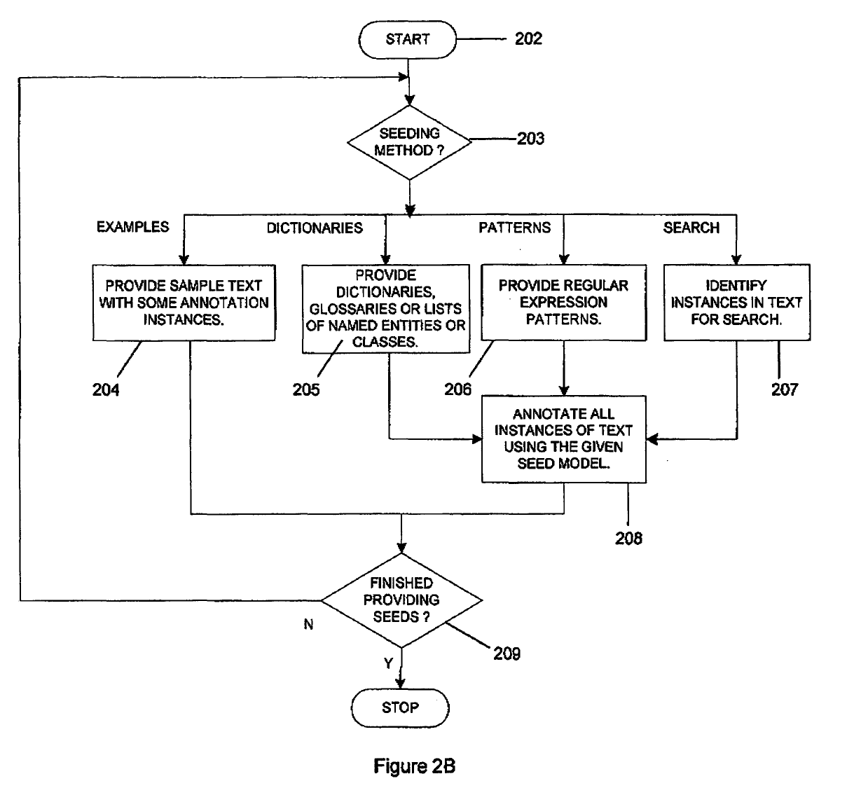

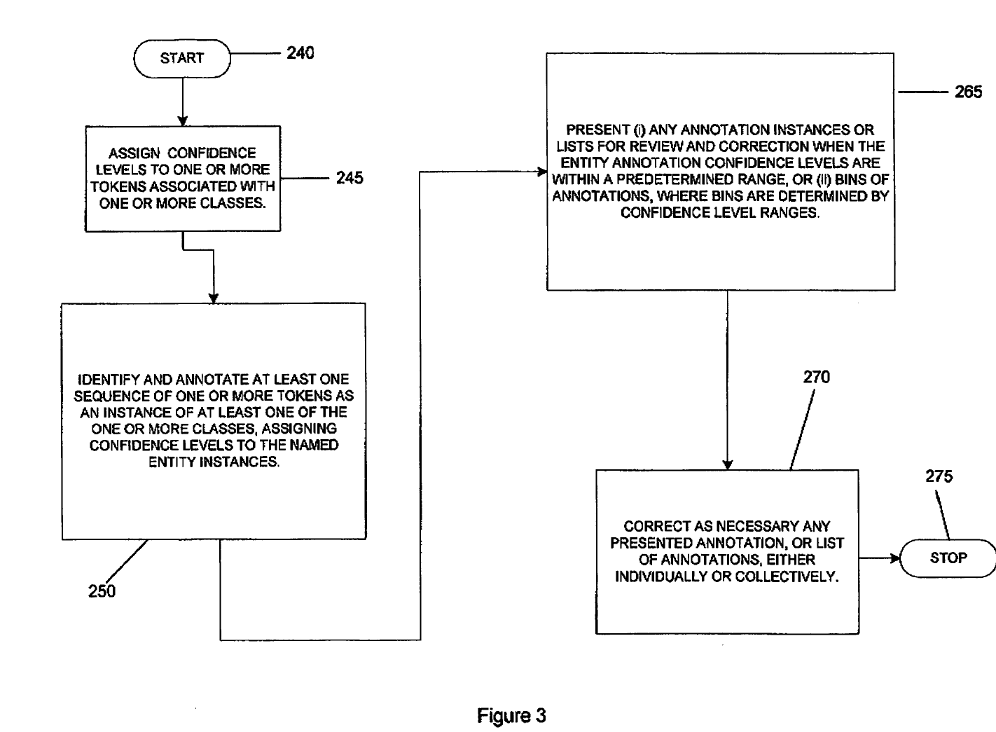

The invention is capable of employing interactive techniques with a user with iterative aspects for, in an embodiment, training and evaluation purposes. Moreover, the use of statistical learning techniques enables the interactive and iterative learning process to be effective, meaning that the learning system quickly converges on accurate annotators. An aspect of the learning component is that they provide confidence levels for instances of named entity annotations. This permits the system and method to determine with confidence which named entity annotations made by the learner should be reviewed by a person or provides other guidance to the person, reducing greatly the time and effort required of a person in the interactive learning process. The processes and steps of the invention are further described with reference to FIGS. 2A-3.

### Specifics of Classifier and Annotator

### Learning Token Classifiers

In one embodiment, for each annotator for a particular class of named entities, a set of token classifiers is learned. The term “token” as used herein is a relative term, meaning the basic units into which the text is decomposed. In the following examples, word-based tokens are used. However, it is possible that a preprocessing step might group some words or even phrases into single tokens before the machine learning phase. These classifiers assign a set of classification outputs (i.e., class labels) and associated confidence values to the tokens of an incoming electronic message or text document. These token classifications and associated confidence levels are used by the method and system of the invention to annotate automatically named entity instances, which are sequences of one or more tokens.

Some of the resulting named entity annotation instances are selectively presented to a user for evaluation and possible correction. The machine learning components are capable of assigning confidence levels to token classifications. Any statistical or other machine learning classification component providing confidence levels can be used in the invention; these include but are not limited to the following types of machine learning techniques:
1. decision trees,
2. neural nets, and
3. linear classifiers of all types, including e.g., Naive Bayes, linear least squares, support vector machines, Winnow and Generalized Winnow

If the classifier confidence levels do not fall within the closed interval [0, 1], then in an embodiment, a transformation will be applied to map the confidence level range onto [0, 1] for purposes of presentation to the user. Hence, the invention distinguishes an internal confidence level from the external confidence level presented to users. Providing such a transformation is common and well understood in the field of machine learning.

Returning to internal confidence levels, in one embodiment, a linear classifier is used such that the threshold of the classifier determining in-class versus out-of-class is typically 0, as discussed in T. Zhang, F. Damerau and D. Johnson, “Text Chunking Based on a Generalization of Winnow”, Journal of Machine Learning, (2002) (Zhang), which is incorporated by reference, herein, in its entirety. That is, any classification instance resulting in a score equal or greater than 0 is in-class.

Any classification instance resulting in a score less than 0 is out-of-class.

The score is the internal confidence level. If the internal confidence levels are not within the interval [0, 1], then in one embodiment, they will be mapped to [0, 1] by an order preserving transformation to provide “external” user-presented confidence levels necessarily always in the interval [0, 1].

“Order-preserving” refers to the relative positions of respective confidence levels in the classifier-determined scale of confidence levels being maintained in the externally provided confidence levels. This ensures the relative confidence of annotation instances is maintained and hence of use to the user in the evaluation and correction phase. These transformed, externally provided confidence levels might or might not directly correspond to reliable estimates of in-class probabilities.

In one embodiment, which uses the Generalized Winnow technique described in Zhang, the applied transformation from internal confidence levels to external user-presented confidence levels do, in fact, reflect reliable estimates of in-class probabilities, as shown in Appendix B of Zhang and hence provides a reliable guide to the user in making evaluation and correction decisions. This is one of the many advantages of the invention. The Generalized Winnow technique provides other advantages, namely, it converges even in cases where the data is not linearly separable and it is robust to irrelevant features.

The purpose of insuring that the externally provided confidence levels fall within the closed interval [0, 1] is to provide the user with precise upper and lower bounds on possible confidence levels (respectively 1 and 0). By way of example, referring to the Generalized Winnow technique, the following simple transformation can be used: 2*Score−1, truncated to [0, 1]. (“Truncated to [0, 1]” refers to that any value derived from the formula: 2*Score−1 that is less than 0 is mapped to 0, and any value so derived that is greater than 1 is mapped to 1.) All other values derived from the formula 2*Score−1 remain the same. In general, the transformations are determined by the loss functions used to train the classifier.

However, although desirable, there is no requirement that confidence levels be within the closed interval of [0,1]. By way of example, after the first learning round, the system might indicate that for the entity “Person”, there are 320 annotations between confidence level 0.9 and 1.0, 420 between 0.9 and 0.8, 534 between 0.8 and 0.7 and so on. The user could then choose to inspect the annotation instances in a “bin” within some lower range, say between e.g., 0.8 and 0.7 and if it turns out on inspection that the assignments appear correct most or all of the time, the user could, with a point and click feedback action, accept all the examples in that bin.

The user may optionally alter the confidence level required for automatic acceptance of possible annotations based on how well the system is performing. The annotations with a confidence level above the system, or user specified level, for acceptance will not be shown to the user, rather those instances of annotations will simply be automatically accepted as valid and used in the next training phase. In a similar fashion, the user may optionally alter the current confidence level setting required for automatic rejection of possible annotations. The annotations with a confidence level for rejection below the specified level will not be shown to the user, rather those instances of annotations will simply be automatically rejected as incorrect and not used in the next training phase. The annotations that fall within the interval between the automatic acceptance and rejection levels are selectively presented to the user for evaluation. Through this mechanism of automatic acceptance and rejection of respectively high confidence and low confidence results, the system can selectively present intermediate range results to the user, greatly leveraging the distinct strengths of the machine learning algorithms and the user, thereby making more effective use of the user's time and skill. By way of example, the user may set the acceptance of the instances in a bin with selectable confidence level interval [a, b]. This may then result in the automatic acceptance of each bin with confidence level [c, d] such that “c” is greater than or equal to “b”.

The view of the annotations in terms of bins whose instances have confidence levels within certain intervals allows a user to evaluate and update the newly annotated data in blocks, which is very efficient since the user does not have to resort to inspecting the each annotation instance in the text document itself. Since the system uses statistical learning methods, which can learn accurate annotators even with some inaccuracies in the training data annotations, manipulating items in a block can still be very effective even if there are some annotation errors in the accepted bins of annotation instances.

The various techniques of organizing and selectively presenting the results of the annotation process, coupled with the iterative learning phases, the use of statistically determined confidence levels, significantly reduces the amount of time required to annotate all of the training data. The selective presentation mechanisms based on confidence levels, in one embodiment, may be combined with list-manipulation and search and global update functions. Combined, the invention provides an extremely powerful method for quickly and accurately labeling training data and learning sets of annotators that can be exported and integrated into runtime systems requiring automatic annotations of classes (i.e., named entities).

In embodiments, the invention provides several selective presentation and training functions such as:
(i) list-based presentation of annotated entities and instance counts with hot links to the actual instance annotations in the training data supporting corrective actions on groups of annotation instances,
(ii) confidence-level interval presentation of entity annotations supporting acceptance or rejection of groups of annotation instances based on the respective confidence levels,
(iii) global search and update functions (annotate, remove annotation, rebracket annotation),
(iv) automatic acceptance or rejection of annotation instances based on pre-set or user-set confidence-level thresholds, and
(v) selective presentation of annotations whose confidence levels are above the auto-rejection confidence level and below the auto-accept confidence level.

In order to train an annotator on a particular class C, the invention uses any one of a number of labeling schemes applicable to tokens in the text, which identifies, explicitly or implicitly, the first and last tokens of a sequence of tokens that refer to a named entity. (The process of determining from token level classifications which sequences of tokens correspond to instances of named entities or classes is referred to as “chunking”.) In one scheme, for k kinds of named entities, there would be 2 k token-level classifiers. An example of an annotated named entity under this scheme would be, where “B-Comp” refers to “begin company name” and E-Comp refers to “end company name”:
“Yesterday, International Business Machines reported”
B-Comp E-Comp
   Another scheme uses three types of labels, two of which are “positive” and one of which is “negative” for: (i) “B-A” for “begin class A”, (ii) “I-A” for “in class A but does not begin class A”, (iii) “0” for “outside any class being learned”. Using this approach, if the system is to learn k classes, then there are 2k+1 labels to be learned and hence 2k+1 token-level classifiers to be trained. Continuing with the above example, this scheme would encode the Company named entity instance as follows:
Yesterday, International Business Machines reported”
O B-Comp I-Comp I-Comp O
   Finally one could use a simplified system in which one only distinguishes in-class and out of any class. Using this scheme the above example would be coded as follows:
“Yesterday, International Business Machines reported”
O I-Comp I-Comp I-Comp O

In the following discussion, for simplicity of presentation, the “I-C, 0” scheme is used for illustration but any of the above coding schemes for classifiers or others could be used within the invention.

To determine an annotation requires first assigning classes to tokens and then evaluating the sequence of token classifications to identify candidate annotations, where each annotation is a sequence of tokens. There are many ways in which entity annotations can be built from basic token classifications in conjunction with the manner in which probabilities of correct assignment of entity annotations is determined; a requirement is that the entity level annotations be assigned confidence levels falling within the closed intervals [0, 1] as this aids the interactive aspect of the invention.

Now referring again to FIG. 1, in the system and method of the invention, a user accesses an interface 110 to choose and create seeds using the seed determination module 121 and a seed database 141 or the like. The seed database contains one or more of three types of seed information: patterns, which when interpreted with respect to sample text identify examples; dictionaries, glossaries or lists of examples; or partially annotated text, where the annotations are examples. The user may provide several types of seeds to the seed determination module 121.

The seeds are then provided to the classifier/annotator trainer module 122 where the sample seed text is processed and resulting tokens marked with token classes. For each named entity type, the learning system learns a set of token-level classifiers, where the number of classifiers is determined by the chosen coding scheme. Updating plug-ins 123 may conceivably be used to alter the coding scheme.

Learning can take place even with errors in the annotated data. In one embodiment, for example, the system assigns to each token and each class, here ICi and O, a confidence level reflecting the possibility that the respective class assignment is correct. One can think of the results for a document or text segment and set classes or types of named entities C₁, . . . , C_{K} as a table or array with columns representing the k+1 token-level classes, the rows representing the tokens and the cells filled with confidence levels (the ni, j):

| | Classes | | | | | |
|---|---|---|---|---|---|---|
| TOKENS | IC1 | IC2 | IC3 | IC4 | . . . | O |
| token-1 | n1, 1 | n1, 2 | n1, 3 | n1, 4 | . . . | n1, k + 1 |
| token-2 | n2, 1 | n2, 2 | n2, 3 | n2, 4 | . . . | n2, k + 1 |
| . . . | . . . | . . . | . . . | . . . | . . . | . . . |
| token-r | nr, 1 | n2, 2 | n2, 3 | n2, 4 | . . . | n2, k + 1 |

In one embodiment, for each token-level class C to be learned, the learning system learns a linear classifier (or linear separator).

Given a linear classifier L(C) for a given class C and an input sequence of feature vectors fv(t1), . . . fv(t1), . . . fv(tr), derived from the input text, the classifier L(C) is applied to each token feature vector fv(t) in the sequence, and outputs for each corresponding token in the sequence a confidence level for every token belonging to class C. How to determine features and automatically convert text tokens to token feature vectors, train on the token feature vectors to derive a linear classifier for a class and then apply the learned classifier to token feature vectors derived from an input text is well understood by one of ordinary skill in the in the art of machine learning as applied to text processing applications.

As there is, in the example coding scheme discussed above, one linear classifier for each of the k+1 classes to be learned, each token in the sequence of tokens in the input text data will be given as input to k+1 classifiers and there will be k+1 confidence levels output for each token, providing the table of confidence level determinations shown schematically above.

### Determining Annotations from Token Class-Assignments

The system and method of the invention then determines, on the basis of the token-level table of confidence numbers, which sequences of tokens represent a particular named entity, such as a company or person name. There are a variety of ways in which this bracketing could be performed.

For example, the algorithm could simply pick for each token, that class whose confidence level is highest, or dynamic programming techniques could be employed, e.g., the Viterbi algorithm, a commonly used technique for efficiently computing most likely paths through a sequence of possible tags (here, the named entity class labels). Providing an appropriate method for chunking token-level classifications into classes is common and well understood in the field of machine learning.

By way of example, the named entity segmentation is determined by processing the table via a computer program to find sequences of tokens which collectively have, relative to all the other possible class assignments, the highest average confidence level for a particular class as discussed below.

Any other method could be used in the context of the current invention. It is significant to realize that according to this invention, a user does not have to explicitly mark each token of a seed example. Rather, through the user interface, a user can simply indicate the beginning and end tokens of a named entity instance, as well as the name of the class.

### Calculation of Annotations from Token Classes

In one embodiment, the system and method of the invention determines the annotations or chunks from the (internal) confidence level assignments assigned to individual tokens as follows. Suppose the results for tokens t1-t8 and classes class 0, class 1, and class 2 are as shown below:

| Token | Class 0 (out of any class) | Class 1 | Class 2 |
|---|---|---|---|
| t1 | −1.5226573944091797 | 1.7719603776931763 | −0.9411153197288513 |
| t2 | −1.5257058143615723 | 1.5968185663223267 | −1.0436562299728394 |
| t3 | 1.1216583251953125 | −1.137298583984375 | −1.7995836734771729 |
| t4 | −2.2069292068481445 | 1.3401074409484863 | 1.6256663799285889 |
| t5 | 1.1220178604125977 | −1.4301049709320068 | −2.0625078678131104 |
| t6 | 1.191319227218628 | −1.6482737064361572 | −1.5037317276000977 |
| t7 | 1.3884899616241455 | −2.528714179992676 | −1.2880574464797974 |
| t8 | 1.120343804359436 | −1.9108299016952515 | −1.4603245258331299 |

The possible sequences of tokens to be chunked together as a named entity instance, i.e., annotated for a given class C, are all sequences of consecutive tokens that have confidence level assignments for C that are above the in-class threshold (0, 0). In the example above, there is a possible candidate annotation or chunk (named entity instance) spanning tokens t1 and t2, [t1, t2], with label class 1. There are no other possible chunks spanning t1 and t2 with other specific named-entity labels, here, [C2] class 2, in the table above as the numbers for class 2 are negative and class 0 is, by definition, outside of any recognized class. There is also a possible chunk spanning just token t4, which could be either Class 1 (with confidence level 1.3401074409484863) or Class 2 (with confidence level 1.6256663799285889), as both confidence levels are positive. On the assumption that the system is assigning at most one class to a particular token sequence, the system would annotate token t4 as belonging uniquely to class 2 as the confidence level is higher for class 2 than for Class 1. It should be noted that the invention is not limited to the case of assigning unique class names to token sequences. In other embodiments, it could assign token t4 to both class 1 and class 2.

In the example embodiment, where to simplify discussion, it is assumed each token sequence is assigned at most one class, for each possible chunk [ti, . . . tr] with label X, a score SX[ti, . . . tk] is computed in the following way:
(1) calculate the average score A1 of the tokens in the possible chunk [ti, . . . , tr] for class X,
(2) calculate the average score A2 for [ti . . . tr] for class 0, and (3) subtract A2 from A1. In the example above, this would mean calculating: ((1.7719.+1.5968.)/2)−((−1.522.+−1.525.)/2).

For possibly overlapping annotations, the system retains that chunk or annotation whose score is highest given the score average of the other overlapping chunks or annotations. For instance, consider the hypothetical assignments:

| | | |
|---|---|---|
| class 1 | t1 t2 t3 t4 t6 t7 t8 t9 | chunks 1 & 2 |
| class 2 | t3 t4 t5 t6 t7 | chunk 3 |
| class 3 | t3 t4 | chunk 4 |

Chunk4 will be retained if its score is higher than the average of the scores for chunk1, chunk2 and chunk3.

Although any machine learning algorithm or combination of algorithms, e.g., as used in boosting, bagging and stacking approaches, capable of assigning confidence levels to class assignments could be used, in one embodiment, the learning technique may include the so-called Generalized Winnow technique. In particular, the Generalized Winnow technique as used in Zhang assigns probabilities of in-class membership to each token and uses these assignments as the basis for determining the annotations.

### Using the Interactive Training

### System of the Invention

The method and system of the invention provides for an interactive learning process for training annotators to recognize, bracket and label, with increasing levels of confidence, sequences of tokens in text constituting the entities of specified type.

In general it is not sufficient to build just a glossary or list of items, rather a system for annotating named entities must have the capability of learning contexts to disambiguate the type of potential entities or class in instances. For instance, “He” could be a pronoun or refer to the chemical element “Helium” and “Madison” might in context refer to a city, a person or some other kind of entity. Therefore, the system and method of the invention cannot simply learn lists of entity mentions, rather it also learns the textual contexts in which particular types of entities occur. By learning the contexts in which named entities of a particular type occur, the system and method can learn to annotate named entities without invoking a specific list or dictionary. The system and method can also learn internal features or characteristics that are distinctive of particular classes, e.g., that names of people in English typically have the initial character capitalized, phone numbers consist of digits in various recognizable formats, many addresses have recognizable syntactic characteristics, etc. How to encode this kind of information (internal and contextual linguistic information) into features that can be used as the input to learning algorithms is well understood and common in the field of machine learning. One approach to this is described in detail in Zhang.

Moreover, it should be understood that there is no guarantee that the seeds or annotations instances resulting from learning are correct. That is, the system and method must form linguistically valid generalizations that can be used to identify new instances of the named entity type in question, and these generalizations are learned and refined or improved through successive rounds of learning, interspersed with user corrections, if needed.

FIGS. 2A-3 show flow charts implementing the steps of the invention. FIGS. 2A-3 may equally represent a high-level block diagram outlining system components of the invention. In the steps of the invention, it should be well understood that the methodology of the invention can be implemented using a plurality of separate dedicated or programmable integrated or other electronic circuits, memories, or devices (e.g., hardwired electronic or logic circuits such as discrete element circuits, or programmable logic devices such as PLDs, PLAs, PALs, or the like). A suitably programmed general purpose computer, e.g., a microprocessor, micro-controller or other processor device (CPU or MPU), either alone or in conjunction with one or more peripheral (e.g., integrated circuit) data and signal processing devices can be used to implement the invention. A user interface appropriate for displaying complex text fields and graphics and also for receiving input from the user is provided. In general, any device or assembly of devices on which a finite state machine capable of implementing the flow charts shown in the Figures can be used as a controller with the invention. The annotators and associated software of the invention can be encapsulated for use and distribution on compact disks, floppy disks, hard drives, or electronically by download from a distribution site (e.g., server), and other like manner.

Referring to FIG. 2A and FIG. 2B, the system and method of using the invention shown begins at step 200 in FIG. 2A, where it is assumed the system has access to a body of unannotated text documents, and proceeds to step 201, the Add Seeds process, whose internal logic is shown in the flow chart of FIG. 2B.

Focusing on FIG. 2B, the user first selects one or more seeding methods 203: Examples (204), Dictionaries, Lists or Glossaries (205), Patterns (206), or Search (207). In particular, the system and method provides several distinct but compatible methods for providing seeds for training. At step 204, the system is provided with sample text containing some annotation instances. At step 205, the system is provided with one or more dictionaries, lists or glossaries of named entities or classes. At step 206, the system is provided with one or more patterns, e.g., regular expressions, that when applied to text, identify annotation instances. At step 207, the system is provided with annotation instances identified in the text by the user and these example instances are used for search against the text data to identify other instances of the user-identified example instances. The user can choose to employ any or all of these options (seed models) for example instances. Once examples are provided, the system annotates all instances of the examples at step 208, generating seeds (annotation instances) in the user provided text data (originally unannotated or partially annotated text). The user then decides 209 whether or not to stop the seeding process, which initiated a training round at step 210 in FIG. 2A. In this way the system and method is provided initial training data.

Returning to FIG. 2A, at step 210, the system, on the basis of the current training data, learns annotators for each type of named entity or class. Then, at step 212, the system applies the annotators learned at this stage or round to the text data, possibly annotating new instances or even correcting previous annotations, and to each annotation instance it assigns a confidence level estimating the probability that the assignment is correct. Based on the confidence levels assigned at step 212, some annotations may, at step 214, be selectively presented for review and, if needed, correction.

Which if any annotation instances will be selectively presented are determined by the system or user determined confidence level range for presentation. This range can be adjusted by the user as the system learns and its annotations become more accurate. It is by virtue of this mixed initiative that the system can start with a small number of seeds and quickly converge on accurate annotators, with minimal human intervention. The confidence levels of the selectively presented annotations are typically those that have a range between 0 and 1. (FIG. 3 further details the use of confidence levels.)

If the selectively presented annotations are not acceptable, the user makes any necessary changes by correcting the annotations at step 218, either selectively by instance, by selecting an entire list of annotations that was presented for viewing, or by inspecting bins of annotation instances in context, where the bins correspond to confidence level ranges. Bins are useful since this allows a user to inspect some examples and if they are correct, choose to accept all instances in that bin with one action. Alternatively, if a user chooses to accept an entire bin of examples within a given confidence level range, the system can also then automatically accept all instances in each bin whose confidence level range is greater than the user-selected bin. Another option is that if the user determines some examples in a particular bin are incorrect, he or she can choose to reject all instances of a bin with one action; alternatively all bins with lower confidence level ranges than the user rejected bin could be rejected with one action. Corrections can consist of deleting annotations (not the text itself, just the annotation information), rebracketing the annotation, i.e., altering the span of tokens in the text that the annotation covers, relabeling the annotation type, adding or deleting an annotation type (if the particular embodiment of the invention supports multiple annotations) or any combination of rebracketing and relabeling that is logically coherent.

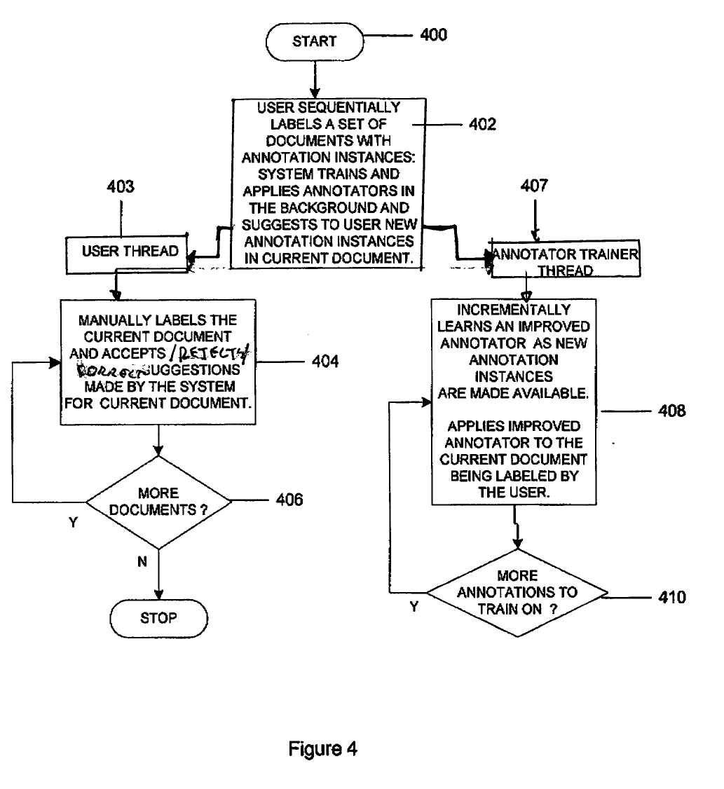

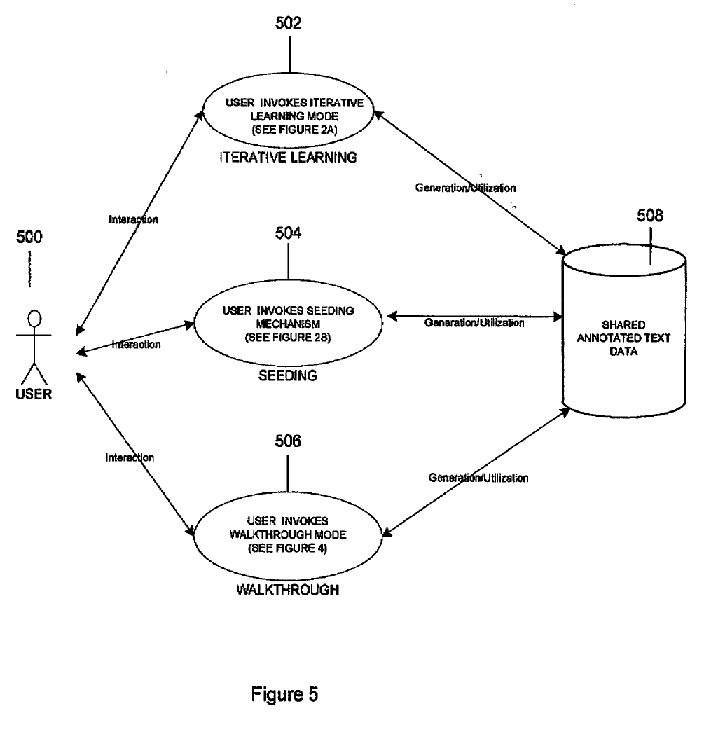

The user may also select a hot-link to review/verify actual instance usage in the text. The user may accept or reject entire lists of annotations with one action for efficiency. (Steps 214, 216 and 218 may be performed by the user interaction module 124 in FIG. 1). Once the user corrects the annotations at step 218, the user chooses to either further augment the seed base at step 220 or to initiate the learning process again at step 210, where the now updated training data is used as input to the next round of annotator learning. It should be noted that in one embodiment, at each stage of learning in the iterative learning loop (210, 212, 214, 216, 218, 219, 210), previous annotators are discarded and entirely new annotators are learned from the current training data. In alternative embodiments, learned annotators might be updated, rather than intiating learning from scratch. This mode of learning annotators anew rather than updating a given current set of annotators contrasts with the mode of learning in the Walk-through mode of use of the invention shown in FIG. 4, discussed below.

If, at step 216, on the other hand, the user decides to stop the annotation/iterative learning phase, then in subsequent step 220, the system generates and exports runtime annotators for general use in applications. In this way the system and method on the basis of unnannotated text data and seeds, iteratively learns, with user review and correction as needed, accurate annotators for named entities or classes in an efficient and effective manner.

It should be recognized that there is no guarantee that the seeding process (FIG. 2A, 201; FIG. 2B) would result in the partially annotated text being completely annotated or correctly annotated. For instance, if a user provides, for example, a list of city names with “Madison”, any particular instance of “Madison” in the unannotated text might or might not actually denote a city. And of course, many city names will typically be left unannotated. Therefore, the system and method of the invention cannot simply learn lists of entity mentions, rather it also learns the textual contexts in which particular types of entities occur. That is, the system and method must form a linguistically valid generalization that can be used to identify new instances of the named entity type in question. By learning the contexts in which named entities of a particular type occur, the system and method can learn to annotate named entities without invoking a specific list or dictionary. The system and method can also learn internal features or characteristics that are distinctive of particular classes, e.g., that names of people in English typically have initial characters capitalized, phone numbers consist of digits in various recognizable formats, many addresses have recognizable syntactic characteristics, etc.

FIG. 3 is a flow diagram illustrating the steps of generally assigning and using confidence levels in determining annotation instances according to the invention, which begins at step 240. The system and method assigns a confidence level to each annotation assignment it makes, indicating an estimate of the probability that the assignment is correct. Confidence levels can be used to make decisions when there is ambiguity, or to optimize a set of assignments where there might be some overlap in tokens representing several annotations. There are a variety of methods for determining or optimizing class assignments well-known and common in the literature on machine learning. Confidence levels can be used to organize and/or filter the data to be selectively presented to the user for evaluation. Therefore, incorporating into the system and method a statistical or other machine learning technique that provides confidence levels indicating the likelihood that the annotation instances are correct is an aspect of providing a successful learning system for named entity or class annotation. In one embodiment, confidence levels would be related to estimates of in-class probabilities.

At step 245, a confidence level is assigned to one or more tokens associated with one or more classes (i.e., entity classes). The confidence levels are assigned as discussed previously. At step 250, sequences of one or more tokens, each of which has a confidence level above an in-class threshold associated with the one or more classes are identified and particular sequences are annotated as belonging to particular classes, according to a so-called chunking algorithm. There are a variety of methods for determining chunks from token-level class or type assignments well known and common in the machine learning literature.

In embodiments, particular sequences of one or more tokens could be assigned one or more classes or types, i.e., assignments can be ambiguous, and in other embodiments, assignments might be unique; further assignments of annotation types to token sequences might or might not permit sequences to be overlapping. The particular constraints on chunking token-level type assignments into chunks depends on the ultimate use of the annotators and could vary from embodiment to embodiment. For the purposes of the invention, which particular method of chunking is immaterial. Subsequently, at step 265, the system presents to the user for review and possible correction, any annotation instances or lists corresponding to annotation instances which fall within a specified (external) confidence level range. The confidence level range can be preset and can be adjustable by the user. Presentation can also be in the form of bins, where each bin contains all annotation instances for each class that fall within a specified confidence level range. At step 270, the presented annotation instances are corrected either individually or collectively as an entire list (or just a part of a list). The method completes at step 275.

Thus, the system and method of the invention may assign confidence levels to the possible named entity or class determinations, facilitating learning useful generalizations even in cases where the annotated examples contain errors and providing information to the selective presentation process. The system and method also may include an interactive capability such that the machine learning process can start from a relatively small set of annotations (“seeds”), possibly containing errors, and via feedback from a user iteratively and incrementally improve its ability to assign annotations correctly and also allows for mechanisms for selectively presenting results and guiding the user in the evaluation and correction process. In each subsequent learning phase, the system and method of the invention will have as input a larger number of correctly annotated examples, which will result in learning more accurate annotators.

In one embodiment, the invention takes a statistical approach in which the annotation techniques provide with each annotation instance, a reliable estimate of the probability that the assignment is correct. Confidence levels are used by the system to selectively present to a user which, if any, annotations should be evaluated for correctness, and corrected if in error. The key to the effectiveness of the current invention is the notion of selective presentation as it is this aspect that both increases the accuracy of the learned annotators and greatly reduces the amount of human labor required to produce accurate annotators.

FIG. 4 presents a different mode of use of the invention, called “Walk-through”, where rather than taking turns in a collaborative loop, both the user and the annotation trainer work on distinct parallel threads (step 403 and step 407). Upon startup (step 400), the user, at step 402, starts to sequentially annotate documents in a document set, ignoring the annotation learner (step 407) altogether. Concurrently to the user labeling data, the annotation learner trains in the background (step 408) on the labeled data as it become available from the user. The annotation learner continuously updates its knowledge state based on the flow of new annotations from the user (step 404) and applies this knowledge state, as an updated annotator, to the current document being labeled by the user to suggest new annotations to the user for the current document as the user is working on it (step 404). At step 404, the user may manually label the current document and
1. the user can explicitly accept the presented annotation instance;
2. the user can explicitly reject the presented annotation instance;
3. the user can rebracket and explicitly accept the presented annotation instance;
4. the user can relabel and explicitly accept the presented annotation instance; and
5. the user can rebracket, relabel and explicitly accept the presented annotation instance.
   Alternatively, if the user takes no action, the system may automatically accept the annotation instance when another document is opened by the user, for example.

The annotation instances may be accepted by not explicitly rejecting any or all of the annotation instances. Likewise, the annotation instances may be accepted by the user explicitly accepting such annotation instances or implicitly accepting such annotation instances by moving to a new document. Alternatively, all of the annotation instances which were corrected, relabeled, rebracketed or added by the user or any combination thereof may be accepted.

It should be recognized that in this mode of use, the embodiment is one in which a given set of annotators are incrementally updated based on new annotation instances, rather than learning annotators anew each time the user makes changes to annotations, as in the previously discussed modes of use. In the walk-through mode of use, it is assumed that the user is inspecting all the data in a current document and is accepting or rejecting suggestions from the concurrent learning process. In contrast, in the other modes of use, it is assumed that at least some of the text data and system determined annotation instances are never seen or reviewed by the user. Critical to the effectiveness of the Walk-through mode of use are confidence levels as these determine which system determined annotations will be displayed to the user in the document the user is currently working on; all other system determined annotation candidates, which fall below the system or user defined confidence level threshold, are discarded (neither displayed to the user nor used to update the training data with new instances). It is this particular use of confidence levels in combination with the particular interaction with the user that makes incrementally updating annotators effective.

The learner process goes on as long as there are annotations made available through user actions or otherwise (step 410). While this process goes on, the user keeps labeling documents (step 404) until he has walked through the entire set at step 406 (or otherwise chooses to stop the process). As the user labels documents in an uninterrupted way, he can add, correct or ignore the suggestions that are made available to him for the current document by the system as he is working on this document (step 404). Suggestions are made to the user only when the proposed annotation score equals or exceeds a threshold that is set by the system or user. This allows the user to adjust the volume of suggestions made by the system. As the system improves its annotators, the user can adjust the confidence levels so that more of its suggestions are presented to the user. This mode of use is referred to as “Walk-through”. Like the other modes of use of the invention, one of the chief benefits of the Walk-through mode is that labeling can, as the system learns, be largely reduced to reviewing annotations, which is faster than reading unannotated text looking for sequence of tokens to annotate. In addition, rather than learn annotators anew each time there are new annotations in the training data, the system can merely update its current set of annotators. Indeed, one can start in this mode with a set of annotators that are imported into the system (via the plug-in box of FIG. 1). The chief distinction from the other modes of use of the invention is that in Walk-through mode, rather than a user controlled interleaved learn, review and correct, learn sequence of rounds, learning is taking place continuously in the background as the user is labeling. In addition, in the Walk-through mode, the seeding process is optional. It should be recognized that in embodiments, a user can alternate between the iterative learning mode and the walk-through learning mode and at any time choose to add more annotation instances via a seeding process.

FIG. 5 shows an overall relationship of the seeding process and alternative learning strategies, iterative (FIG. 2A) and concurrent walk-through (FIG. 4). The user (500) has, as appropriate, the option at any point of invoking the interactive learning mode (502), the seeding mechanism (504) or the concurrent walk-through learning mode. Each of the options (502, 504, 506) use or update a common database of text data with annotation instances (508).

While the invention has been described in terms of embodiments, those skilled in the art will recognize that the invention can be practiced with modification within the spirit and scope of the appended claims.

1. A method of learning annotators for use in an interactive machine learning system, the method comprising the steps of:
providing at least partially annotated text data or unannotated text data with seeds or seed models of instances of at least one named entity or class to be learned;
iteratively learning annotators for the at least one named entity or class using a machine learning algorithm;
applying the learned annotators to text data resulting in the annotation of at least one named entity or class annotation instance; and
selectively presenting for review and correction, if determined, representations of the at least one named entity or class annotation instance identified by the applying of the learned annotators.

2. The method of claim 1, wherein the annotations instances are selectively presented for review and correction, if determined, based on a predetermined threshold value of a confidence level.

3. The method of claim 1, wherein the step of iteratively learning includes incrementally improving the learned annotators.

4. The method of claim 1, wherein the at least one named entity is any syntactic, semantic or notional type that can be identified as a type and named.

5. The method of claim 1, wherein the seeds or seed models are at least one of lists, dictionaries, glossaries, patterns and database entries.

6. The method of claim 1, further comprising providing a log of corrections of removed or altered annotation instances.

7. The method of claim 6, wherein the log of corrections are optionally used to override any of the at least one named entity or class annotation instance inconsistent with the log.

8. The method of claim 1, further including preprocessing groups of words or phrases into single units before the iteratively learning step.

9. The method of claim 1, wherein the applying step provides confidence levels for each annotation instance such that the learned annotators and their respective confidence levels are used to selectively present some of the representations of the at least one named entity or class annotation instance.

10. The method of claim 9, wherein if confidence levels do not fall within a closed interval then a transformation will be applied to map a confidence level range onto the closed interval [0 . . . 1] for purposes of presentation to the user.

11. The method of claim 9, further including adjusting a threshold of the confidence levels associated with each of the annotation instances for one of:
(i) an automatic acceptance of the at least one named entity or class annotation instance,
(ii) an automatic rejection of the at least one named entity or class annotation instance, and
(iii) the selective presentation of the at least one named entity or class annotation instance.

12. The method of claim 11, wherein:
the annotation instances above the adjusted confidence level will automatically be accepted as valid and used in a next training phase; and
the annotation instances below the adjusted confidence level will automatically be rejected as invalid.

13. The method of claim 1, wherein learning the annotator for a particular named entity or class includes using labeling schemes.

14. The method of claim 1, wherein the learned annotators are applied to text data to annotate new instances or correct previous annotations, wherein each of the at least one named entity or class annotation instance is assigned a confidence level estimating a probability that the assignment is correct.

15. The method of claim 1, wherein when the selectively presented annotations are not acceptable, the changes are made by one of:
(i) selecting specific annotation instances,
(ii) selecting an entire list of annotation instances that was presented for viewing, and
(iii) inspecting bins of the annotation instances in context, where the bins correspond to confidence level ranges.

16. The method of claim 15, wherein the bins allow a user to inspect some examples and if they are correct, choose to one of accept and reject with one action all instances in that bin.

17. The method of claim 16, wherein if the user determines some examples in a particular bin of the inspected bins are correct, all of the at least one named entity or class annotation instance can be accepted within the particular bin and all bins with higher confidence level ranges than the accepted bin such that, at one time, entire groups of all the at least one named entity or class annotation instance can be accepted.

18. The method of claim 16, wherein if the user determines some examples in a particular bin of the inspected bins are incorrect, all of the at least one named entity or class annotation instance can be rejected within the particular bin and all bins with lower confidence level ranges than the rejected bin such that, at one time, entire groups of all the at least one named entity or class annotation instance can be rejected.

19. The method of claim 1, further comprising correcting the at least one named entity or class annotation instance by deleting annotation instances, rebracketing annotation instances, relabeling annotation instances, adding or deleting annotation instances or any combination of rebracketing and relabeling.

20. The method of claim 1, wherein one of:
at each stage of learning in the iterative learning step, previously learned annotators are discarded and entirely new annotators are learned from current training data, and
at each stage of learning in the iterative learning step, previously learned annotators are updated.

21. The method of claim 1, further comprising correcting the annotation instances when a confidence level associated with the annotation instances falls within a predetermined range.

22. The method of claim 1, wherein confidence levels associated with each of the annotation instances is generated using the Generalized Winnow learning algorithm.

23. The method of claim 1, wherein the step of iteratively learning annotators includes the step of determining that a sequence of token level classifications and associated confidence levels constitutes an instance of a type of named entity or class.

24. The method of claim 23, wherein the determining step determines that a consecutive sequence of one or more tokens each of which is labeled with one or more of the types of named entity or class and each type assignment of which has an associated confidence level that equals or exceeds a required confidence level to be in a type of named entity or class is a candidate annotation instance of the type of named entity or class.

25. A method of learning annotators for use in an interactive machine learning system for processing electronic text, the method comprising the steps of:
providing examples of a type of a named entity and unannotated textual data; and
iteratively learning annotators based on at least one of the examples of a named entity and unannotated textual data, where at the end of each iteration, any annotation, generated from the learned annotators, having a confidence level within a confidence level range is presented for review and, if required, corrected based on feedback.

26. A method of learning annotators for use in an interactive machine learning system, the method comprising the steps of:
a user sequentially labeling annotation instances in a current document from a document set;
a machine learning algorithm concurrently training on the documents in the document set to learn at least one annotator for at least one named entity or class; and
assigning a confidence level to each of the annotation instances by the learned at least one annotator such that any annotation instance which has a confidence level that is equal to or above a predetermined confidence level threshold and that occurs in a current document being labeled will be presented to the user for review and possible action.

27. The method of claim 26, further comprising discarding the annotation instances determined by the machine learning system which fall below the predetermined confidence level threshold.

28. The method of claim 27, wherein each named entity or class type has a separate confidence level threshold.

29. The method of claim 26, wherein the machine learning system continuously updates its knowledge state based on flow of new annotations from the labeled documents and applies this knowledge state, as an updated annotator or annotators, to a current document being labeled to suggest a new or new annotations for the current document being worked on.

30. The method of claim 26, further comprising providing sample text with seeds for the type of named entity or class as training data.

31. The method of claim 26, wherein the review and possible correction step includes at least one of:
the user explicitly accepting the presented annotation instance;
the user explicitly rejecting the presented annotation instance;
the user rebracketing and explicitly accepting the presented annotation instance;
the user relabeling and explicitly accepting the presented annotation instance; and
the user rebracketing, relabeling and explicitly accepting the presented annotation instance.

32. The method of claim 26, further comprising accepting annotation instances which are not explicitly rejected by the user.

33. The method of claim 32, wherein the accepting of annotation instances not explicitly rejected by the user is accomplished implicitly by the user moving to a new document or explicitly by taking an acceptance action.

34. The method of claim 26, further comprising accepting annotation instances which were corrected, relabeled, rebracketed or added by the user.

35. An apparatus for learning annotators for use in an interactive machine learning system for processing electronic text, comprising:
a means for providing at least partially annotated text data or unannotated text data with seeds or seed models of instances of at least one named entity or class to be learned;
a means for iteratively learning annotators for the at least one named entity or class using a machine learning algorithm from the at least one named entity or class;
a means for applying the learned annotators to text data resulting in the annotation of at least one named entity or class annotation instance; and
a means for selectively presenting for review and correction, if determined, representations of annotation instances identified by the learned annotators.

36. The apparatus of claim 35, further comprising a component to export the final annotators for use in processing electronic text.

37. The apparatus of claim 35, further comprising a component to determine confidence levels associated with the individual annotation instances.

38. An apparatus for learning annotators for use in an interactive machine learning system for processing electronic text, comprising:
means for providing examples of a type of a named entity and unannotated textual data; and
means for iteratively learning annotators based on at least one of the examples of a named entity and unannotated textual data, where at the end of each iteration, any annotation, generated from the learned annotators, having a confidence level within a confidence level range is corrected based on feedback.

39. A computer program product comprising a computer usable medium having a computer readable program code embodied in the medium, the computer program product includes:
a first computer component to provide at least partially annotated text data or unannotated text data with seeds or seed models of instances of at least one named entity or class to be learned;
a second computer component to iteratively learn annotators for the at least one named entity or class using a machine learning algorithm from the at least one named entity or class;
a third computer component to apply the learned annotators to text data resulting in the annotation of at least one named entity or class annotation instance; and
a fourth computer program component to selectively present for review and correction, if determined, representations of annotation instances identified by the learned annotators.
